(19) United States
(12) Patent Application Publication
(10) Pub. No.: US 2023/0075556 A1
(43) Pub. Date: Mar. 9, 2023

(54) Lithium-Ion Battery System and Battery State Estimation System

(71) Applicant: APB Corporation, Tokyo (JP)

(72) Inventors: Hideaki Horie, Tokyo (JP); Yohji Kawasaki, Kyoto-shi, Kyoto (JP); Yusuke Mizuno, Kyoto-shi, Kyoto (JP)

(21) Appl. No.: 17/798,174

(22) PCT Filed: Feb. 8, 2021
(86) PCT No.: PCT/JP2021/004611

§ 371 Date: Aug. 8, 2022

(30) Foreign Application Priority Data
Feb. 7, 2020 (JP) 2020-019899

(51) Int. Cl. H01M 10/0525; H01M 10/28; H01M 10/48

(52) U.S. Cl. CPC H01M 10/0525; H01M 10/281; H01M 10/48

(57) ABSTRACT

A lithium-ion battery system which can appropriately determine the presence or absence of an abnormality of a unit cell. It is provided with an assembled battery formed by stacking a plurality of battery units, each of the plurality of battery units including a unit cell consisting of a lithium-ion battery and a signal output part provided in the unit cell; a signal receiving part for receiving an optical signal output by the signal output part in each of the plurality of battery units; an analysis processing part for analyzing the optical signal received by the signal receiving part; and a state determination part for determining that the assembled battery is abnormal in accordance with the analysis result of the analysis processing part.

### TECHNICAL FIELD

The present invention relates to a technique for estimating the state of a lithium-ion battery.

### BACKGROUND ART

A lithium-ion battery has been conventionally proposed as a secondary battery suitable for various fields such as an electric vehicle or a mobile terminal. For example, Patent Literature 1 discloses the assembled battery having a structure in which a plurality of unit cells composed of a lithium-ion battery are stacked.

### CITATION LIST

### Patent Literature

PTL 1: Japanese Patent Laid-Open No. 2019-207750

### SUMMARY OF INVENTION

### Technical Problem

The assembled battery may have an abnormality in the process of its use (e.g., at the time of generating an abnormal voltage rise or the temperature rising to an abnormal level). The object of the present invention properly is to appropriately determine the presence or absence of an abnormality.

### Solution to Problem

A lithium-ion battery system according to an aspect of the present invention is provided with an assembled battery formed by stacking a plurality of battery units, each of the plurality of battery units including a unit cell consisting of a lithium-ion battery and a signal output part provided in the unit cell; a signal receiving part for receiving an optical signal output by the signal output part in each of the plurality of battery units; an analysis processing part for analyzing the optical signal received by the signal receiving part; and a state determination part for determining that the assembled battery is abnormal in accordance with the analysis result of the analysis processing part, wherein the signal output part generates a first optical signal by changing an optical signal pattern during a predetermined unit period in accordance with the state of the unit cell, and generates a second optical signal that is the optical signal pattern having the largest light emission period ratio in the unit period among the optical signal patterns when the unit cell is in an abnormal state; and when the analysis processing part analyzes the signal receiving part as being received by the second optical signal, the state determination part determines the assembled battery as being abnormal.

### BRIEF DESCRIPTION OF DRAWINGS

FIG. 1 is a block diagram illustrating a structure of a battery system according to the embodiments.

FIG. 2 is a perspective view illustrating the structure of the lithium-ion battery system.

FIG. 3 is a perspective view illustrating a structure of a battery unit.

FIG. 4 is a cross-sectional view of the a-a line in FIG. 3.

FIG. 5 is a perspective view illustrating a configuration of a signal output part.

FIGS. 6(a) to 6(e) and 6(g) to 6(k) are schematic diagrams illustrating optical signal patterns, and FIG. 6(f) is a schematic diagram illustrating the optical signal pattern when the unit cell is in an abnormal state.

FIGS. 7(a) to 7(c) are schematic diagrams of the optical signal transmitted by a light guide.

FIG. 8 is a block diagram illustrating a configuration of a battery state estimation system.

FIG. 9 is a block diagram illustrating a functional configuration of a control device.

FIG. 10 is a flowchart illustrating a specific procedure of a state estimating process.

FIG. 11 is a perspective view illustrating the structure of the battery unit.

FIG. 12 is a perspective view illustrating the configuration of the signal output part.

### DESCRIPTION OF EMBODIMENTS

### A: First Embodiment

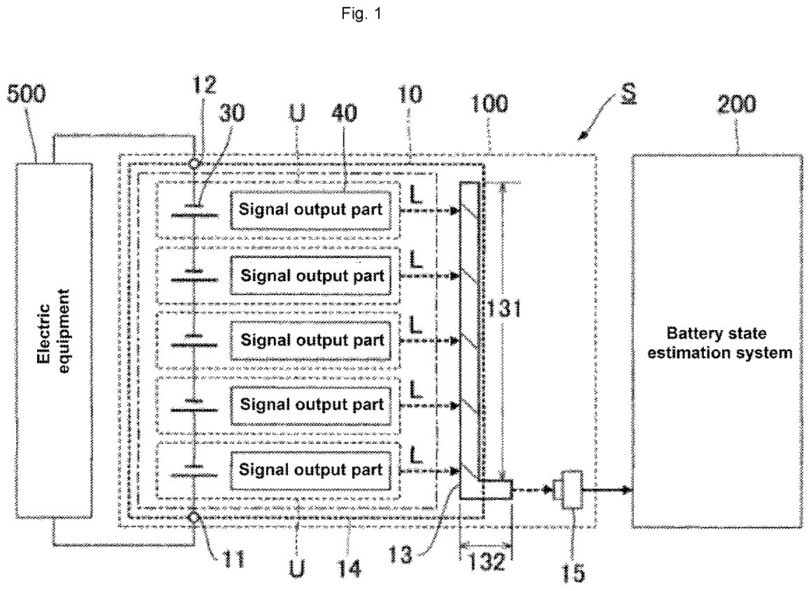

FIG. 1 is a block diagram illustrating a structure of a battery system S according to a suitable embodiment of the present invention. A battery system S is equipped with a lithium-ion battery system 100 and a battery system estimation system 200. The lithium-ion battery system 100 is a power supply device that supplies electric power to various electric equipment 500 such as an electric vehicle or a mobile terminal.

The battery system estimation system 200 estimates the state of the lithium-ion battery system 100. The battery system estimation system 200 is capable of communicating with the lithium-ion battery system 100. Specifically, the battery system estimation system 200 communicates with the lithium-ion battery system 100 via a known communication network such as the Internet or Ethernet (registered trademark). It is also assumed that the lithium-ion battery system 100 and the battery system estimation system 200 are configured to be connected via a communication cable.

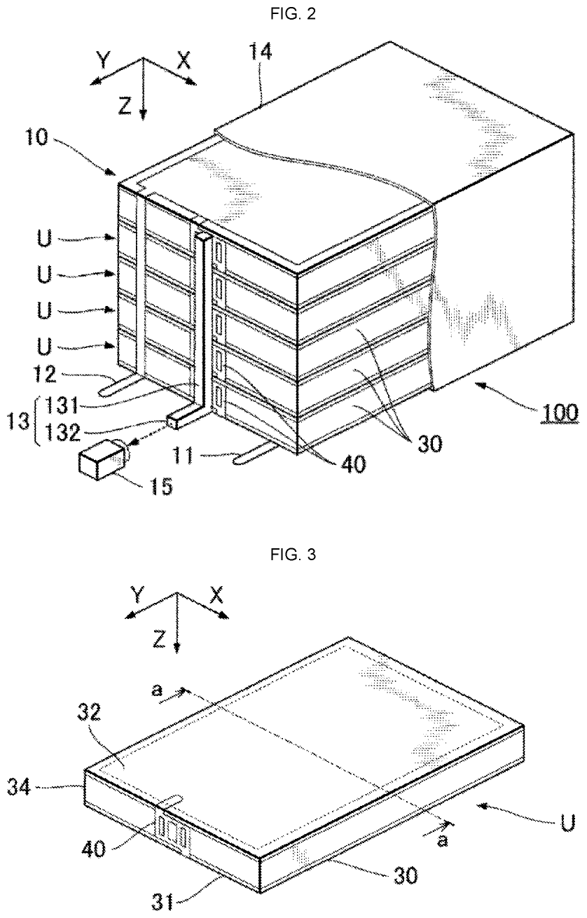

FIG. 2 is a perspective view illustrating the structure of the lithium-ion battery system. As illustrating in FIGS. 1 and 2, the lithium-ion battery system 100 of this embodiment is equipped with an assembled battery 10, a positive electrode terminal 11, a negative electrode terminal 12, a light guide 13, an exterior body 14, and a light receiving device 15. The assembled battery 10 is equipped with a plurality of battery units U. In FIG. 2, a part of the extender body 14 is omitted for convenience. The extender body 14 is a container for accommodating a plurality of battery units U. The extender body 14 is configured by a metal case or a composite film, for example.

As illustrated in FIG. 2, it is assumed that the X-axis, Y-axis, and Z-axis are orthogonal to each other. A plurality of battery units U is stacked in the Z-axis direction in the internal space of the extender body 14. Each of the plurality of battery units U is equipped with a unit cell 30 and a signal output part 40. More specifically, the signal output part 40 is arranged for each unit cell 30. The unit cell 30 is a secondary battery composed of a lithium-ion battery. In addition, the plurality of battery units U may be configured to be stacked and connected in series as follows. Specifically, a plurality of unit cells 30 is stacked in the direction of the Z-axis so that a positive electrode current collector 311 in one unit cell 30 is in contact with a negative electrode current collector 321 in the other unit cell 30 adjacent to the aforesaid unit cell 30 in the positive direction of the Z-axis, and each of the unit cells 30 is connected in series. In this stacked structure, a current collector is constituted by stacking the positive electrode current collector 311 and the negative electrode current collector 321. It can be said that such a stacking structure is a configuration in which a positive electrode is formed on one surface of the current collector and a negative electrode is formed on the other surface to form a bipolar (bipolar) type electrode, and the bipolar (bipolar) type electrode is stacked with a separator. The positive electrode terminal 11 in FIG. 2 comes into contact with the positive electrode current collector 311 of one unit cell 30 located at the bottom of the plurality of unit cells 30. On the other hand, the negative electrode terminal 12 comes into contact with the negative electrode current collector 321 of the unit cell 30 located in the uppermost layer of the plurality of unit cells 30. As illustrated in FIG. 1, the positive electrode terminal 11 and the negative electrode terminal 12 are electrically connected to the electric equipment 500.

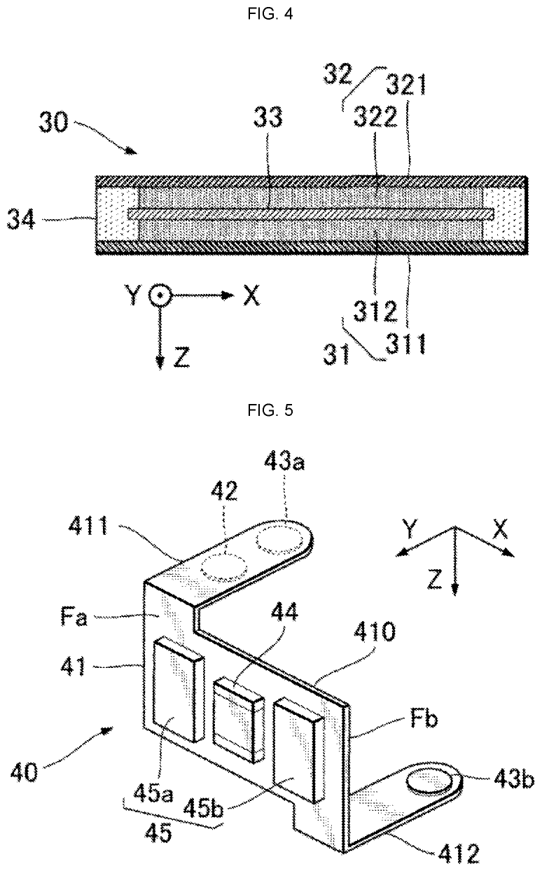

FIG. 3 is a perspective view illustrating the structure of any one battery unit U, and FIG. 4 is a cross-sectional view of the line a-a in FIG. 3. The unit cell 30 is a structure formed into a rectangular shape when seen in a plan view from the direction of the Z-axis, and is configured in a flat plate shape parallel to the X-Y plane. As illustrated in FIGS. 3 and 4, the unit cell 30 is a stacked body in which a separator 33 is interposed between a positive electrode 31 and a negative electrode 32. The positive electrode 31 is located in the positive direction of the Z-axis with respect to the separator 33, and the negative electrode 32 is located in the negative direction of the Z -axis with respect to the separator 33.

The positive electrode 31 is composed of the positive electrode current collector 311 and a positive electrode active material layer 312. The positive electrode current collector 311 is a rectangular conductive film parallel to the X-Y plane. The positive electrode active material layer 312 includes a positive electrode active material and an electrolytic solution, and is formed on the surface of the positive electrode current collector 311 facing the separator 33. On the other hand, the negative electrode 32 is composed of the negative electrode current collector 321 and a positive electrode active material layer 322. The negative electrode current collector 321 is a rectangular conductive film parallel to the X-Y plane. The negative electrode active material layer 322 includes a negative electrode active material and an electrolytic solution, and is formed on the surface of the negative electrode current collector 321 facing the separator 33.

A frame-like body 34 is interposed between the positive electrode current collector 311 and the negative electrode current collector 321. The frame-like body 34 is a rectangular frame-shaped structure that is formed to have the same external dimensions as the positive electrode current collector 311 and the negative electrode current collector 321. The frame-like body 34 supports the periphery of the separator 33 formed in a rectangular shape over the entire circumference. As can be understood from the above explanation, the positive electrode active material layer 312 is interposed between the positive electrode current collector 311 and the separator 33, and the negative electrode active material layer 322 is interposed between the negative electrode current collector 321 and the separator 33. More specifically, the unit cell 30 is a structure in which the positive electrode current collector 311, the positive electrode active material layer 312, the separator 33, the negative electrode active material layer 322, and the negative electrode current collector 321 are stacked in this order.

Any known material is used to form each element constituting the unit cell 30. Examples of specific materials are as follows.

The materials of the positive electrode current collector 311 and the negative electrode current collector 321 (hereinafter collectively referred to as “current collector”) are, for example, various metal materials (copper, aluminum, titanium, stainless steel, nickel, and alloys of the above metals), calcined carbon, conductive polymer material, or conductive glass.

A resin current collector formed of a conductive polymer material may be used as the positive electrode current collector 311 or the negative electrode current collector 321. Examples of the conductive polymer material constituting the resin current collector include polyethylene (PE), polypropylene (PP), polymethylpentene (PMP), polycycloolefin (PCO), polyethylene terephthalate (PET), polyethernitrile (PEN), polytetrafluoroethylene (PTFE), styrene-butadiene rubber (SBR), polyacrylonitrile (PAN), polymethylacrylate (PMA), polymethyl methacrylate (PMMA), polyvinylidene fluoride (PVdF), epoxy resins, and silicone resins. A mixture of two or more materials selected from the above examples may constitute a resin current collector.

The positive electrode active material of the positive electrode active material layer 312 is, for example, a multiple oxide of lithium and a transition metal. The multiple oxide is, for example, a multiple oxide having one kind of transition metal (LiCoO₂, LiNiO₂, LiAlMnO₄, LiMnO₂, LiMn₂O₄), and a multiple oxide having two kinds of transition metals (LiFeMnO₄, LiNi₁₋ₓCoₓO₂, LiMn_{1-y}Co_{y}O₂, LiNi_{1/3}Mn_{1/3}Co_{1/3}O₂, LiNi_{0.8}Co_{0.15}Al_{0.05}O₂), or a multiple oxide (LiMₐM′_{b}M′_{c}O₂) with three types of transition metals. M, M′ and M″ are different transition metals, and a+b+c=1 holds.

Other examples of positive electrode active materials include, for example, lithium-containing transition metal phosphates (LiFePO₄, LiCoPO₄, LiMnPO₄, LiNiPO₄), transition metal oxides (MnO₂, V₂O₅), transition metal sulfides (MoS₂, TiS₂), or conductive polymers (polyaniline, polypyrrole, polythiophene, polyacetylene, poly-p-phenylene, and polyvinylcarbazole). Two or more types of matrials selected from the above examples may be used as positive electrode active materials. Some of the transition metal sites of the lithium-containing transition metal phosphates may be substituted by another transition metal.

The negative electrode active material of the negative electrode active material layer 322 is carbon-based materials, for example. Examples of the carbon-based material include, for example, graphite, non-graphitizable carbon, amorphous carbon, resin calcined materials (those carbonized by calcining phenolic resin and furan resin), cokes (pitch coke, needle coke, and petroleum coke), or carbon fibers. Other examples of the negative electrode active material include silicon-based materials. Examples of the silicon-based materials include, for example, silicon, silicon oxide (SiOx), silicon-carbon composites, silicon alloys (silicon-aluminum alloy, silicon-lithium alloy, silicon-nickel alloy, silicon-iron alloy, silicon-titanium alloy, silicon-manganese alloy, silicon-copper alloy, or silicon-tin alloy). Further, other examples of the negative electrode active material includes, for example, conductive polymers (polyacetylene, polypyrrole), metals (tin, aluminum, zirconium, titanium), metal oxides (titanium oxide, lithium-titanium oxide), or metal alloys (lithium-tin alloy, lithium-aluminum alloy, and lithium-aluminum-manganese alloy). A mixture of the materials selected from the above examples and the carbon-based material may be used as the negative electrode active material.

The electrolyte is, for example, inorganic acid lithium salts (LiN(FSO₂)₂, LiPF₆, LiBF₄, LiSbF₆, LiAsF₆, and LiClO₄) or organic acid lithium salts (LiN(CF₃SO₂)₂, LiN(C₂F₅SO₂)₂, and LiC(CF₃SO₂)₃). Examples of the nonaqueous solvent used for the electrolyte solution include, for example, a lactone compound, cyclic carbonate ester, chain carbonate ester, chain carboxylic acid ester, cyclic ether, chain ether, phosphoric ester, nitrile compound, amide compound, sulfone, sulfolane, and the like. A mixture of two or more materials selected from the above examples and the material may be used as the negative electrode active material.

The signal output part 40 in FIG. 2 is arranged in the unit cell 30. The signal output part 40 arranged in each of the unit cells 30 outputs an optical signal L in accordance with the state (specifically, temperature and voltage) of the unit cell 30 concerned. FIG. 5 is a perspective view illustrating the configuration of the signal output part 40 in any one battery unit U. As illustrated in FIG. 5, the signal output part 40 of this embodiment is equipped with a wiring board 41, a temperature sensor 42, a voltage detecting part 43 (43a, 43b), a light emitting part 44, and a light emission control part 45 (45a, 45b). The light emitting part 44 and the light emission control part 45 are operated by the power supplied from the unit cell 30, for example.

The wiring board 41 is a mounting component in which wiring is formed on the surface of the insulating board. For example, a rigid printed board or a flexible printed board is used as the wiring board 41. As illustrated in FIG. 5, the wiring board 41 is equipped with a base body part 410, a first extension portion 411, and a second extension portion 412 are provided. The base body part 410 is a flat plate-shaped portion formed in a rectangular shape. Of the base body part 410, the light emitting part 44 and the light emission control part 45 are mounted on a surface Fa located in the positive direction of the Y-axis.

The first extending part 411 and the second extending part 412 are the portions of the base body part 410 that extend in the negative direction of the Y-axis from a surface Fb on the opposite side of the surface Fa. The first extending part 411 extends in the negative direction of the Y-axis from the portion of the upper edge of the base body part 410 located in the negative direction of the X-axis, and the second extending part 412 extends in the negative direction of the Y-axis from the portion of the lower edge of the base body part 410 located in the positive direction of the X-axis. As can be understood from the above explanation, the position of the first extending part 411 and the position of the second extending part 412 in the direction of the X-axis are different from each other. More specifically, the first extending part 411 and the second extending part 412 do not overlap each other when seen in a plan view from the Z-axis direction. Further, the position of the first extending part 411 and the second extending part 412 in the Z-axis direction are different from each other. As can be understood from FIG. 3, the signal output part 40 is arranged in the unit cell 30 by sandwiching the unit cell 30 between the first extending part 411 and the second extending part 412. Specifically, in the state where the surface Fb of the base body part 410 faces the side surface of the unit cell 30, the first extending part 411 faces the upper surface of the unit cell 30 (the surface of the negative electrode current collector 321) and the second extending part 412 faces the lower surface of the unit cell 30 (the surface of the positive electrode current collector 311). The structure for arranging the signal output part 40 on the unit cell 30 is not limited to the above illustration. For example, the signal output part 40 may be accommodated in a notch (recess) formed on the outer peripheral surface of the frame-like body 34. More specifically, the signal output part 40 is embedded in the frame-like body 34.

The temperature sensor 42 detects the temperature Q of the unit cell 30. For example, a known temperature sensitive element such as a resistance thermometer or a thermistor is used as the temperature sensor 42. The temperature sensor 42 of this embodiment is arranged on the surface of the first extending part 411 facing the unit cell 30 (more specifically, the surface in the positive direction of the Z-axis). The temperature sensor 42 is electrically connected to the light emission control part 45 via the wiring of the wiring board 41. The position of the temperature sensor 42 is not limited to the illustration shown in FIG. 5. For example, the temperature sensor 42 may be arranged on the surface Fb of the base body part 410.

The voltage detecting part 43 detects the voltage V across both electrodes of the unit cell 30. The voltage detecting part 43 of this embodiment includes a first detection terminal 43a and a second detection terminal 43b. The first detection terminal 43a is arranged on the surface of the first extending part 411 facing the unit cell 30 (more specifically, the surface in the positive direction of the Z-axis). The first detection terminal 43a comes into contact with the negative electrode current collector 321 of the unit cell 30 so as to detect the potential of the negative electrode current collector 321. On the other hand, the second detection terminal 43b is arranged on the surface of the second extending part 412 facing the unit cell 30 (more specifically, the surface in the negative direction of the Z-axis). The second detection terminal 43b comes into contact with the positive electrode current collector 311 in the unit cell 30 so as to detect the potential of the positive electrode current collector 311. The difference between the potential of the negative electrode current collector 321 detected by the first detection terminal 43a and the potential of the positive electrode current collector 311 detected by the second detection terminal 43b is the voltage V of the unit cell 30.

The light emitting part 44 is a light source that emits light of a predetermined wavelength. The light emitting part 44 is arranged on the surface of the base body part 410 (more specifically, the surface opposite to the unit cell 30) of the wiring board 41. The light emitting part 44 is a light source such as an LED (Light Emitting Diode).

The light emission control part 45 in FIG. 5 controls the light emitting part 44. The light emission control part 45 of this embodiment is composed of a first control part 45a and a second control part 45b. Each of the first control part 45a and the second control part 45b is achieved by an IC chip mounted on the wiring board 41. The temperature sensor 42 and the first detection terminal 43a are electrically connected to the first control part 45a via the wiring formed on the wiring board 41. The second detection terminal 43b is electrically connected to the second control part 45b via the wiring formed on the wiring board 41. The first control part 45a and the second control part 45b cooperates with each other to control the light emitting part 44. Specifically, the light emission control part 45 controls the light emission of the light emitting part 44 in accordance with the temperature Q detected by the temperature sensor 42 and the voltage V detected by the voltage detecting part 43. Controls the emission of emitting part 44. The light emission control part 45 may be configured with a single IC chip.

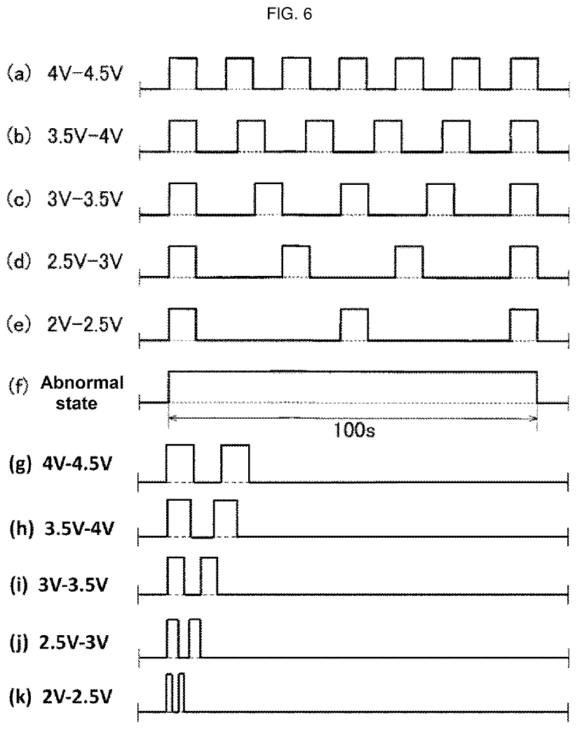

FIGS. 6(a) to 6(k) are schematic diagrams of the pattern of light emission by light emitting part 44 (hereinafter referred to as “optical signal pattern”). As illustrated in FIGS. 6(a) to 6(k), the light emission control part 45 causes the light emitting part 44 to emit light with an optical signal pattern in accordance with the state of the unit cell 30 (the temperature Q and the voltage V). Specifically, FIG. 6(a) is the optical signal pattern when the voltage V is 4V to 4.5V; FIG. 6(b) is the optical signal pattern when the voltage V is 3.5V to 4V; FIG. 6(c) is the optical signal pattern when the voltage V is 3V to 3.5V; FIG. 6(d) is the optical signal pattern when the voltage V is 2.5V to 3V; and FIG. 6(e) is the optical signal pattern when the voltage V is 2V to 2.5V. Each of the optical signal pattern is a pulse pattern that repeats ON (emission of light)/OFF (extinguishing) of the signal within a predetermined length of period (hereinafter referred to as “unit period”). The unit period is, for example, a period of 100 seconds. However, the time length of the unit period is arbitrary. The light emitting part44 may emit light only for one unit period or repeat the same optical signal pattern over multiple unit periods. Further, as illustrated in FIG. 6(g) to FIG. 6(k), the optical signal pattern in each voltage range is not necessary to repeat ON/OFF throughout the unit period, and may be a pattern in which the optical pulse is turned ON/OFF only in a specific short time during the unit period.

The examples of FIG. 6(a) to FIG. 6(e) and FIG. 6(g) to FIG. 6(k), the optical signal pattern is set so that one light-emitting time is the same and the increase in the voltage V causes the greater the number of ON/OFF repetitions, however, any optical signal pattern can be used as long as the voltage V and the shape of the optical signal pattern correspond to each other. For example, the optical signal pattern may be used in which the number of times of light emission ON/OFF is the same and the increase in the voltage V makes the one-time light-emitting time longer. Further, the one-time light-emitting time in the unit period is not necessary to be the same. Further, the shape of the optical signal pattern is varied by in 0.5V increment of the voltage, however, the increment width of the voltage is not particularly limited.

FIG. 6(f) is a schematic diagram illustrating the optical signal pattern in the state where an abnormality has occurred in the unit cell 30 (hereinafter referred to as “abnormal state”). The abnormal state refers to the state where the temperature Q of the unit cell 30 is higher or lower than the appropriate temperature range Qn normally used, or the voltage V of the unit cell 30 is higher or constant than the appropriate voltage range Vn normally used. When the unit cell 30 is in an abnormal state, the light emission control part 45 causes the light emitting part 44 to emit light with an optical signal pattern that means an abnormal state, as shown in FIG. 6(f). The optical signal pattern in the abnormal state is the light mission pattern with longer light-emitting time than the extinguishing time compared to the optical signal pattern illustrated in FIGS. 6(a) to 6(e) and FIGS. 6(g) to 6(k), i.e., having the highest light emission period ratio during the unit period. The light emission period ratio in a unit period is defined as the ratio of the light emission (ON) period to the total period of the unit period in an optical signal pattern as illustrated in FIG. 6(a) to (k). Here, the light emission period ratio in a unit period is defined as the ratio of the period of light emission (ON) with respect to the total period of the unit period. The light emission period ratio in the unit period may be up to 1, and when the light emission period ratio in the unit period=1, the light emission becomes continuous. When the unit cell 30 is in the normal state, the light emission period ratio in the unit period of the optical signal pattern is set to, for example, 0.01 or less, preferably 0.004 or less (for example, from FIG. 6(g) to FIG. 6(k)), whereas when the unit cell 30 is in an abnormal state, the light emission period ratio in the unit period of the optical signal pattern is set to, for example, 0.1 or more, preferably 0.2 or more, and more preferably 0.5 or more (for example, FIG. 6(f)). In this manner, it is possible to reliably detect the abnormal state of the unit cell 30 by setting an easily identifiable optical signal pattern in advance.

As can be understood from the above explanation, the light emission control part 45 controls the light emitting part 44 so as to cause the light emitting part 44 to output the optical signal L corresponding to the temperature Q detected by the temperature sensor 42 and the voltage V detected by the voltage detecting part 43. The optical signal L is output from the signal output part 40 of the battery unit U including the unit cell 30 in abnormal state among a plurality of battery units U. Specifically, the optical signal L is output from the light emitting part 44 corresponding to the unit cell 30 not within the appropriate temperature range Qn that the temperature Q normally uses, or the unit cell 30 not within the appropriate voltage range Qn that the voltage V normally uses.

The light guide 13 in FIGS. 1 and 2 is, for example, an optical element formed of a light-transmitting resin material, and guides the optical signal L output from each of the signal output parts 40 of a plurality of battery units U to the light receiving device 15. The light guide 13 of this embodiment is equipped with an introducing part 131 and a propagating part 132. The introducing part 131 and the propagating part 132 are integrally formed. A bundle of a plurality of optical fiber may be used as the light guide 13, for example.

The introducing part 131 is the portion that extends in the direction of the Z-axis over a plurality of battery units U. As illustrated in FIG. 2, the introducing part 131 faces each light emitting part 44 of a plurality of battery units U. Therefore, the emitted light from each light emitting part 44 (i.e., the optical signal L) is incident on the introducing part 131. The propagating part 132 is arranged at the end part in the positive direction of the Z axis of the introducing part 131. The propagating part 132 is the part that propagates the optical signal L incident on the introducing part 131 from each light emitting part 44 to the light receiving device 15. The propagating part 132 extends in the direction of the Y-axis so that the tip end part thereof is located outside the extender body 14. As can be understood from the above explanation, the optical signal L output from the light emitting part 44 of each battery unit U is transmitted to the light receiving device 15 through the light guide 13.

The light receiving device 15 receives light supplied from the light guide 13. The light receiving device 15 of this embodiment serves as a signal receiving part that receives the optical signal L output by each signal output part 40 of a plurality of battery units U. The light receiving device 15 of this embodiment outputs an electric signal (hereinafter referred to as “state signal”) corresponding to the optical signal L. Specifically, the light receiving device 15 is provided with, for example, a light receiving element, a recording device, and a transmitting device. The light receiving element is, for example, a photodiod whose light receiving surface faces the tip end surface of the propagating part 132 in the light guide 13. The recording device holds a state signal in accordance with the amount of light received by the light receiving element. The transmitting device transmits the state signal recorded in the recording device to the outside.

In addition, the optical signal L is introduced from the light emitting part 44 of a plurality of battery units U to the light guide 13, so that the transmission will be in a crossing state inside the light guide 13. However, the optical signal pattern in the abnormal state has the time length to maintain ON (light emission) that is sufficiently long compared to other optical signal patterns. In addition, while the time length of the unit period is specified by a clock signal generated by an oscillation circuit incorporated in the light emission control part 45, the cycle of the clock signal varies for each light emission control part 45, so that the time length of the unit period is different for each light emission control part 45. Therefore, even if an optical signal pattern similar to the abnormal optical signal pattern is formed by overlapping a plurality of optical signal patterns (FIG. 6(a) to FIGS. 6(e) and 6(g) to 6(k)) corresponding to the normal state in a specific unit period, it is unlikely in the subsequent unit period that the same optical signal pattern will be formed again due to overlapping of a plurality of optical signal patterns corresponding to the normal state. In the above configuration, it is possible to determine that each unit cell 30 is in an abnormal state even in a crossing state by continuously observing the optical signal pattern within a period over a plurality of unit periods.

As described above, in this embodiment, the optical signal L output from each battery unit U is transmitted to the light receiving device 15, so that the wiring for electrically connecting the assembled battery 10 and the battery system estimation system 200 is not required. Therefore, the configuration of the lithium-ion battery system 100 can be simplified. For example, the advantage is provided in which the number of parts of the lithium-ion battery system 100 can be reduced and the manufacturing process of the lithium-ion battery system 100 can be simplified. In this embodiment, there is also a particular advantage that the optical signal L output from the light emitting part 44 of each battery unit U can be reliably and easily transmitted to the battery system estimation system 200 by the light guide 13. Further, the light receiving device 15 or the battery system estimation system 200 avoid being supplied with a large current from the assembled battery 10, so that it is not necessary to arrange a protection mechanism assuming a large current in the battery system estimation system 200, for example.

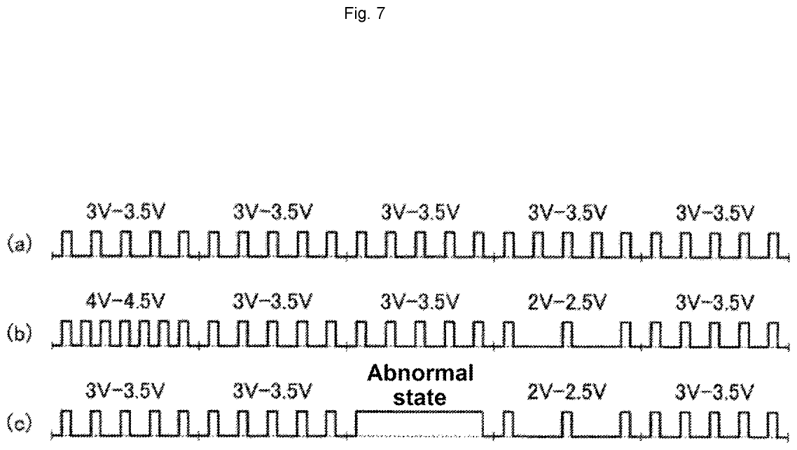

FIGS. 7(a) to 7(c) are schematic diagrams illustrating the optical signal L transmitted to the light receiving device 15 by the light guide 13. FIG. 7(a) shows that all the optical signal patterns divided for each unit period are the patterns corresponding to the voltage of 3V to 3.5V, and all the voltages V of the unit cells 30 are within the range of 3V to 3.5V.

FIG. 7(b) shows that the optical signal patterns divided for each unit period are one optical signal pattern corresponding to the voltage of 2V to 2.5V, three optical signal patterns corresponding to the voltage of 3V to 3.5V, and one optical signal pattern corresponding to the voltage of 4V to 4.5V, which means that the voltage V varies for each unit cell 30. The unit cell 30 with extremely low voltage V may be short-circuited, and the unit cell 30 with extremely high voltage V may be overcharged.

FIG. 7(c) shows that the optical signal patterns divided for each unit period are three optical signal patterns corresponding to the voltage of 3V to 3.5V, one optical signal pattern corresponding to the voltage of 2V to 2.5V, and one optical signal pattern corresponding to the abnormal state, which means that one unit cell 30 is in the abnormal state. As can be understood from the above explanation, it can be determined from the optical signal pattern shown in FIG. 7(a) to FIG. 7(c) that some unit cells 30 out of a plurality of unit cells 30 are in the abnormal state.

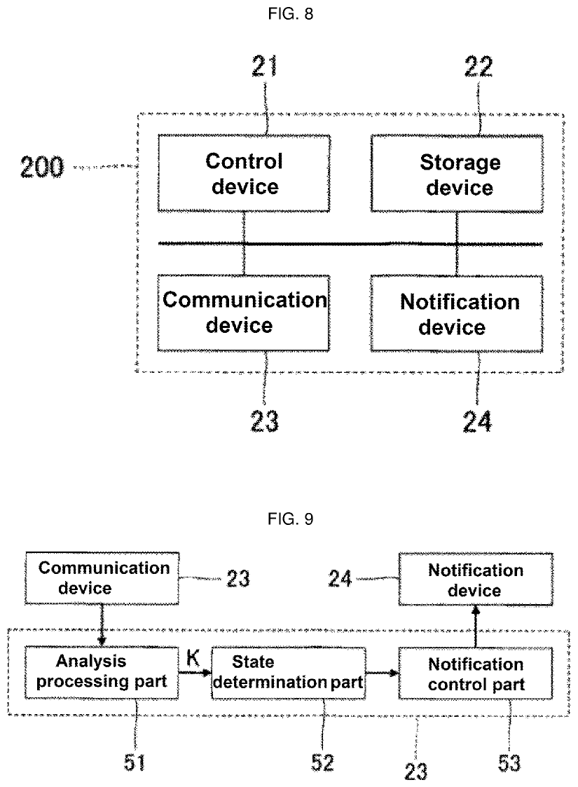

The battery system estimation system 200 is the system that estimates the state of the assembled battery 10 by analyzing the optical signal L received by the light receiving device 15. FIG. 8 is a block diagram illustrating the configuration of the battery system estimation system 200. As illustrated in FIG. 8, the battery system estimation system 200 is equipped with a control device 21, a storage device 22, a communication device 23, and a notification device 24.

The control device 21 is a single processor or a plurality of processors for controlling each element of the battery system estimation system 200. Specifically, the control device 21 is configured by, for example, one or more processor such as CPU (Central Processing Unit), DSP (Digital Signal Processor), FPGA (Field Programmable Gate Array), or ASIC (Application Specific Integrated Circuit).

The storage device 22 is a single memory or a plurality of memories for storing programs executed by the control device 21 and various data used by the control device 21. For example, the storage device 22 is configured by a known recording medium such as a semiconductor recording medium and a magnetic recording medium. The storage device 22 may be configured by combining a plurality of types of recording media. The communication device 23 receives the state signal output by the light receiving device 15.

The notification device 24 is an output device that notifies a user of the abnormality of the assembled battery 10. Specifically, the notification device 24 is a display device that notifies a user of the abnormality of the assembled battery 10 by displaying an image, and a sound emitting device that notifies a user of the abnormality of the assembled battery 10 by emitting voice such as an alarm sound. The notification device 24 may be configured with only one out of the display device and the sound emitting device. Further, a vibration device that notifies a user of the abnormality of the assembled battery 10 by vibration may be used as the notification device 24. As can be understood from the above explanation, the notification device 24 serves as an abnormality notification part for notifying the abnormality of the assembled battery 10.

FIG. 9 is a block diagram illustrating the functional configuration of the control device 21. As illustrated in FIG. 9, the control device 21 of this embodiment executes a program stored in the storage device 22 so as to achieve a plurality of functions (an analysis processing part 51, a state determination part 52 and a notification control part 53).

The analysis processing part 51 analyzes the state signal received by the communication device 23 (that is, the optical signal L received by the light receiving device 15 from each battery unit U) so as to specify the number K of the unit cell 30 in the abnormal state among the unit cells 30 of a plurality of battery units U. In this embodiment, as described above, the optical signal pattern of the abnormal state is output from the signal output part 40 corresponding to the unit cell 30 in the abnormal state. Therefore, the analysis processing part 51 counts, as the number K, the total number of battery units U that the optical signal patterns thereof in an abnormal state are received by the light receiving device 15.

The state determination part 52 determines the presence or absence of an abnormality in the assembled battery 10 in accordance with the number K analyzed by the analysis processing part 51. Specifically, the state determination part 52 determines that an abnormality occurs in the assembled battery 10 when the number K exceeds a predetermined threshold value Kₜₕ. The threshold value Kₜₕ is set to a numerical value greater than or equal to 2. More specifically, the state determination part 52 determines that an abnormality occurs in the assembled battery 10 as a whole when abnormalities are found in two or more predetermined number of unit cells 30. More specifically, even if the unit cell 30 in the abnormal state is present in assembled battery 10, the number K less than or equal to the threshold value Kₜₕ results in the determination that there is no abnormality in the assembled battery 10 as a whole. The threshold value Kₜₕ may be a fixed value set in advance, or may be a variable value that is changed in response to instructions from external devices.

The notification control part 53 causes the notification device 24 to notify the user of the abnormality of the assembled battery 10. Specifically, the notification control unit 53 causes the notification device 24 to perform an operation to notify the abnormality of the assembled battery 10 when the state determination part 52 determines that the assembled battery 10 has an abnormality. Specifically, the notification control unit 53 causes the notification device 24 to carry out the operation to notify the abnormality of the assembled battery 10.

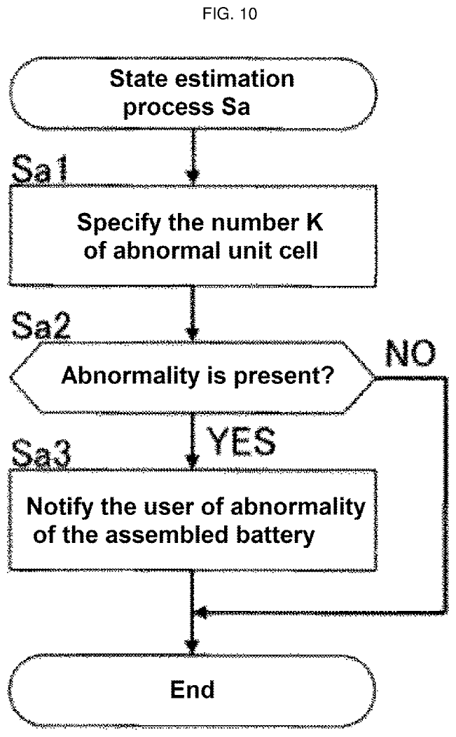

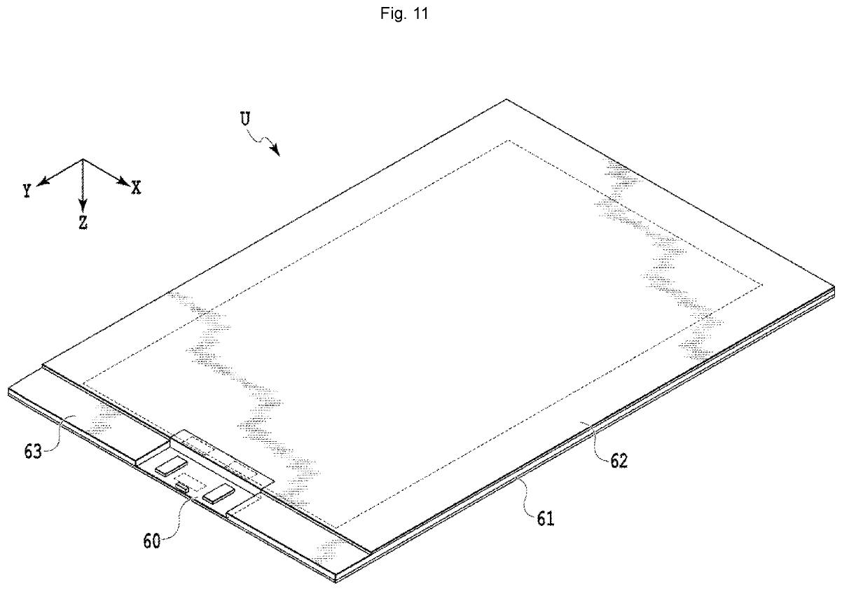

FIG. 10 is a flowchart illustrating a specific procedure of the process (hereinafter referred to as “state estimation process”) Sa executed by the control device 21. The control device 21 repeats the state estimation process Sa in FIG. 10 in a predetermined cycle.

When starting the state estimation process Sa, the control device 21 (the analysis processing part 51) analyzes the state signal received by the communication device 23 so as to identify the number K of the unit cells 30 in the abnormal state (Sa1). The control device 21 (the state determination part 52) compares the number K with the threshold value Kₜₕ so as to determine the presence or absence of abnormality in the assembled battery 10 (Sa2). Specifically, the state determination part 52 determines that the assembled battery 10 is in an abnormal state when the number K exceeds the threshold value Kₜₕ, and determines that the assembled battery 10 is in a normal state when the number K is less than or equal to the threshold value Kₜₕ.

When determining that the abnormality occurs in the assembled battery 10 (Sa2: YES), the control device 21 (the notification control part 53) causes the notification device 24 to notify the user of the abnormality of the assembled battery 10 (Sa3). On the other hand, when determining that there is no abnormality in the assembled battery 10 (Sa2: NO), the control device 21 terminates the state estimation process Sa without carrying out the notification of abnormality (Sa3).

As described above, in this embodiment, the number K of the unit cells 30 in the abnormal state is specified by analyzing the optical signal L (state signal) output for each unit cell 30, and if the number K exceeds the threshold value Kₜₕ, it is determined that an abnormality occurs in the assembled battery 10. Therefore, even if the unit cell 30 in the abnormal state is present in the assembled battery 10, the number K less than or equal to the threshold value Kₜₕ results in the determination that there is no abnormality in the assembled battery 10 as a whole. More specifically, only when the number K of the unit cells 30 reaches a value exceeding the threshold value Kₜₕ, it is determined that the assembled battery 10 has an abnormality. Therefore, the presence or absence of an abnormality in the assembled battery 10 as a whole can be appropriately determined, and the reliability of the determination result can be improved. The state determination part 52 described above may have an estimating part for estimating the abnormal state of the unit cell adjacent to the unit cell in an abnormal state. Specifically, the state determination part 52 may have an estimating part that estimates the abnormal state of the unit cell adjacent to the unit cell analyzed by the analysis processing part 51 as being in an abnormal state (an abnormal unit cell) by using an optical signal corresponding to the temperature detected by the temperature sensor provided in the abnormal unit cell concerned, and the state determination part 52 may determine that the assembled battery 10 has an abnormality in accordance with the estimation result by the estimating part (the estimation result of the abnormal state of the unit cell adjacent to the abnormal unit cell analyzed as an abnormal state). Further, the state determination part 52 may have an estimating part that estimates the abnormal state of the unit cell adjacent to the aforementioned abnormal unit cell in accordance with the temperatures detected by each of the temperature sensors provided in each of the abnormal unit cell and the unit cell adjacent to the abnormal unit cell, and may estimate the abnormality of the assembled battery 10 in accordance with the analysis processing result by the analysis processing part 51 (the result analyzed as an abnormal state by the analysis processing part 51) and the estimation result by the estimating part (the estimation result of the abnormal state of the unit cell adjacent to the abnormal unit cell that was analyzed as abnormal state). By such a configuration, in the case where the stacking state of each unit cell constituting the assembled battery 10 is a stacking state in which the unit cell adjacent to that unit cell is easily affected by temperature (e.g., the stacking state in which the positive electrode current collector 311 and the negative electrode current collector 321 are stacked to form a current collector, and a positive electrode formed on one side of the current collector and a negative electrode formed on the other side constitute a bipolar (bipolar) type electrode), the above-mentioned estimating part estimates the abnormal state of the unit cell adjacent to the abnormal unit cell, and the state determination part 52 can properly determine the presence or absence of the abnormality of the assembled battery 10 in accordance with the estimation result.

In this embodiment, the optical signal L that reflects not only the temperature Q of the unit cell 30 but also the voltage V is output from the battery unit U. Therefore, as compared with the configuration that detects only the temperature Q of the unit cell 30, it is possible to accurately determine the presence or absence of an abnormality in each unit cell 30. Further, in this embodiment, the user is notified of an abnormality when it is determined that there is an abnormality in the assembled battery 10, so that the user can stop using the assembled battery 10, or quickly take appropriate action such as the repair of the assembled battery 10.

### B: Second Embodiment

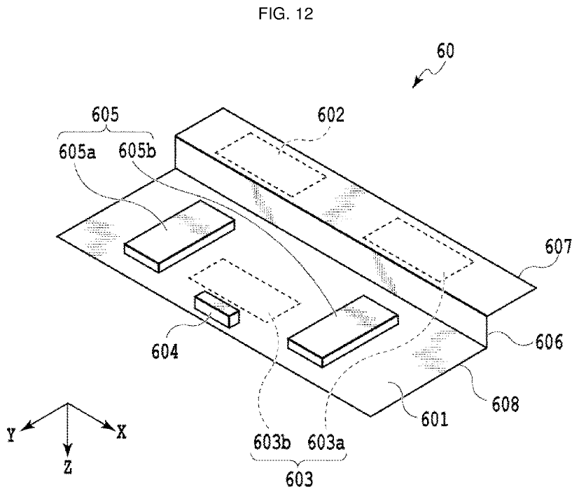

Next, the second embodiment of the lithium-ion battery system and the battery system estimation system according to the present invention will be described with reference to FIGS. 11 and 12. This embodiment differs from the first embodiment described above in that a signal output part 60 in the battery unit U is arranged at a step portion provided at the peripheral portion of the battery unit U.

FIG. 11 shows a perspective view of the battery unit U in this embodiment, and FIG. 12 shows a perspective view of the signal output part 60 in this embodiment. The unit cell 30 is a structure formed into a rectangular shape when seen in a plan view from the direction of the Z-axis, and is configured in a flat plate shape parallel to the X-Y plane. As illustrated in FIG. 4, the unit cell 30 is a stacked body in which a separator 33 is interposed between a positive electrode 61 and a negative electrode 62. The positive electrode 31 is located in the positive direction of the Z-axis with respect to the separator 33, and the negative electrode 62 is located in the negative direction of the Z-axis with respect to the separator 33. As shown in FIG. 11, the negative electrode 62 of the battery unit U in this embodiment has a shorter length in the direction of Y-axis than that of the positive electrode 61. Further, the frame 63 has a notch on one side of the peripheral edge portion. Each of the components configured in this way is stacked so as to form a battery with a step created by a notch on one side of the peripheral edge portion, as shown in FIG. 11. In this step portion, the positive electrode 61 is exposed when seen in a plan view from the direction of the Z-axis. The battery unit has the form in which the signal output part 60 is connected to the step portion.

In order to adapt to the battery with such an aspect, the signal output part 60 shown in FIG. 12 is applied, which has a different shape from the signal output part 40 applied in the first embodiment. The signal output part 60 is the same as the first embodiment in that it is equipped with a wiring board 601, a temperature sensor 602, a voltage detecting part 603 (603a, 603b), a light emitting part 604, and a light emission control part 605 (605a, 605b) arranged on the wiring board 601. Further, also in this embodiment, the voltage detecting part 603 includes a first detection terminal 603a and a second detection terminal 603b, and the light emission control part 605 is composed of a first control part 605a and a second control part 605b, similar to the first embodiment. The wiring board 601 of the signal output part 60 has a side wall portion 606 whose size on the X-Y plane fits with the above-mentioned step portion provided on the battery side and is equal to the height of the step portion. Further, it is provided with an upper step portion 607 that communicates with the upper part of the side wall portion 606, and the temperature sensor 602 and the first detection terminal 603a are arranged on the surface of the upper step portion 607 that is connected to the negative electrode 62. The second detection terminal 603b is arranged on the surface of a lower step portion 608 connected to the positive electrode 61, and the first control part 605a and the second control part 605b are arranged on the opposite surface.

In the signal unit 60, the temperature sensor 602 and the first detection terminal 603a are connected to the negative electrode 62, and the second detection terminal 73b and the positive electrode 61 are connected to the positive electrode 61, all of which are arranged at a step portion provided on one side of the peripheral portion of the battery. Each joint is required to be electrically connected, and thus the connection is made using a conductive tape or an anisotropic conductive film, for example.

The signal output part 60 configured in this manner and the battery unit U provided therewith are structured so that the signal output part 60 is located inside the battery unit (a circuit board structure on the cell), so that the structure can be achieved in which the signal output part does not protrude from the side of the battery unit U, as in the signal output part 60 in the first embodiment. Further, the same effect as in the first embodiment can be obtained even in this configuration.

### C: Variations

The aspects illustrated above may be varied in a variety of ways. Specific variations applicable to the above-described aspects will be illustrated below. Two or more variations arbitrarily selected from the following examples may be combined to the extent that they are not mutually contradictory.

(1) In the aspect described above, the optical signal L of the optical signal pattern indicating the abnormal state is generated by light emitting part44 when the unit cell 30 is in an abnormal state, however, the signal output part 40 may output the optical signal L representing the temperature Q detected by the temperature sensor 42 and the voltage V detected by the voltage detecting part 43. For example, the light emission control part 45 cause the light emitting part 44 to emit light with an optical signal pattern corresponding to the temperature Q and the voltage V. More specifically, the optical signal L indicating the temperature Q and the voltage V is output in parallel from each of the light emitting parts 44 of a plurality of battery units U irrespective of the presence or absence of an abnormality in the unit cell 30. The analysis processing part 51 specifies the number K of the unit cells 30 in which the temperature Q indicated by the optical signal L exceeds the threshold value Qₜₕ or the voltage V indicated by the optical signal L exceeds the threshold value Vₜₕ.

As can be understood from the above illustrations, the optical signal L output by the signal output part 40 is comprehensively expressed as a signal in accordance with the state of the unit cell 30 (the temperature Q or the voltage V). More specifically, the concept of “optical signal” encompasses a signal indicating the abnormality of the unit cell 30, as well as a signal indicating the characteristic values of the unit cell 30 (temperature Q and voltage V).

(2) In the aspect described above, the presence or absence of an abnormality in the unit cell 30 is determined in accordance with the temperature Q and voltage V of the unit cell 30, however, the presence or absence of an abnormality in the unit cell 30 may be determined in accordance with only one of the temperature Q and the voltage V. The voltage detecting part 43 is omitted in the configuration where only the temperature Q is used to determine the abnormality of the unit cell 30, and the temperature sensor 42 is omitted in the configuration where only the voltage V is used to determine the abnormality of the unit cell 30.

(3) The configuration for transmitting a plurality of optical signals L corresponding to different unit cells 30 by a common light guide 13 is not limited to the above illustrations. For example, in a configuration in which the wavelength of the emitted light is different for each light emitting part 44, the light receiving device 15 separately receives the optical signal L supplied from the light guide 13 for each wavelength of the light emitted by the light emitting part 44. Further, for example, time division multiplexing in which the optical signal L corresponding to each unit cell 30 is transmitted within different periods on the time axis can be utilized to transmit a plurality of optical signals L to the battery system estimation system 200 by the common light guide 13. In addition, the oscillation cycle of the IC chip constituting the light emission control part 45 differs for each individual body. Considering the difference in the oscillation cycle for each light emission control part 45, the optical signal L for each light emitting part 44 may be separated from the light receiving result by the light receiving device 15. Further, the optical signal from each light emitting part 44 may be guided to the light receiving device 15 via the light guide arranged individually for each battery unit U.

(4) According to the aspect described above in which the wavelength of each optical signal L is different, it is possible to identify the unit cell 30 in an abnormal state among a plurality of unit cells 30 constituting the assembled battery 10. However, it is not essential in the present invention to specify the unit cell 30 in the abnormal state. A configuration that can specify the number K of the unit cells 30 in the abnormal state in the assembled battery 10 is suitable.

(5) In the aspect described above, the optical signal L corresponding to the state of each unit cell 30 is transmitted from the assembled battery 10 to the battery system estimation system 200; however, the signal in accordance with the state of the unit cell 30 is not limited to the optical signal L that utilizes light. An electrical signal in accordance with the state of each unit cell 30 may be transmitted from each signal output part 40 to the battery system estimation system 200 by means of a signal line connecting the signal output part 40 of each battery unit U and the battery system estimation system 200. The signal output by the signal output part 40 is comprehensively expressed as a state signal in accordance with the state of the unit cell 30.

(6) In the aspect described above, it is determined that the unit cell 30 is in an abnormal state when the voltage V of the unit cell 30 exceeds the threshold value Vth. However, the abnormally is also assumed that the voltage V of the unit cell 30 abnormally drops. Therefore, the state determination part 52 may determine that the unit cell 30 is in an abnormal state when the voltage V of the unit cell 30 is lower than the threshold value Vₜₕ. Further, it may be determined that the unit cell 30 is in an abnormal state when the voltage V is lower than the predetermined threshold value Vₜₕ₁, or when the voltage V exceeds a predetermined threshold value Vₜₕ₂ (Vₜₕ₂>Vₜₕ₁).

(7) In the aspect described above, the battery system S equipped with the lithium-ion battery system 100 and the battery system estimation system 200 is illustrated, however, the battery system estimation system 200 may be mounted on the lithium-ion battery system 100.

### D: Additional Remarks

The following aspects can be grasped from the illustrations explained above.

The lithium-ion battery system according to an aspect (first aspect) of the present invention is equipped with an assembled battery formed by stacking a plurality of battery units, each of the plurality of battery units including a unit cell composed of a lithium-ion battery and a signal output part for outputting an optical signal in accordance with the state of the unit cell; a signal receiving part for receiving an optical signal output by the signal output part in each of the plurality of battery units; an analysis processing part for analyzing the optical signal received by the signal receiving part so as to specify the number of unit cell in the abnormal state out of the unit cells in the plurality of battery units; and a state determination part for determining that the assembled battery is abnormal when the number specified by the analysis processing part exceeds the threshold value. In the aspect described above, the number of the unit cells in the abnormal state is specified by analyzing the optical signal output for each unit cell, and if the number concerned exceeds the threshold value, it is determined that an abnormality occurs in the assembled battery 10. Therefore, even if the unit cell 30 in the abnormal state is present in the assembled battery. More specifically, even if the unit cell in the abnormal state is present, the number less than or equal to the threshold value results in the determination that there is no abnormality in the assembled battery as a whole. Therefore, the presence or absence of an abnormality in the assembled battery as a whole can be appropriately determined. Further, since the optical signal output by the signal output part of each battery unit is transmitted to the signal receiving part, there is no need for wiring to electrically connect the assembled battery and the signal receiving part. Therefore, the advantage of simplifying the configuration is provided (and also the increase in the number of parts or the complexity of the manufacturing process can be suppressed).

In the specific example (second aspect) of the first aspect, the signal output part in each of the plurality of battery units includes a temperature sensor for detecting the temperature of the unit cell of the battery unit, a light emitting part for emitting light, and a light emission control part that controls the light emitting part so as to cause light emitting part to output the optical signal in accordance with the temperature detected by the temperature sensor. According to the aspect above, it is possible to output the optical signal with a simple configuration that controls the light emitting part for each unit cell.

In the specific example (third aspect) of the second aspect, the light emission control part causes the light emitting part to output the optical signal indicating an abnormality of the unit cell when the temperature detected by the temperature sensor exceeds the threshold value. According to the above aspect, the optical signal indicating an abnormality of the unit cell can be generated with a simple configuration that controls the light emitting part.

In the specific example (fourth aspect) of the second or third aspect, each of the signal output part in each of the plurality of battery units includes a voltage detecting part for detecting a voltage of the unit cell in the battery unit concerned, and the light emission control part controls the light emitting part to cause the light emitting part to output the optical signal corresponding to the temperature detected by the temperature sensor and the voltage detected by the voltage detecting part. According to the above aspect, the optical signal that reflects not only the temperature of the unit cell but also the voltage is output from the battery unit, so that, as compared with the configuration that detects only the temperature of the unit cell, it is possible to accurately determine the presence or absence of an abnormality in each unit cell.

In any of specific example (fifth aspect) of the second to fourth aspect, the light emitting part in each of the plurality of battery units emits light with different wavelengths, and the analysis processing part analyzes the optical signal for each wavelength received by the signal receiving part. According to the above aspect, since the optical signals with different wavelengths are output from each of the plurality of battery units, the optical signal can be separated for each wavelength (i.e., for each battery unit). Therefore, it is possible not only to determine which cell out of the plurality of unit cells is in the abnormal state, but also to identify the unit cell that is in an abnormal state among the plurality of unit cells.

The lithium-ion battery system according to any of specific example of the first to fifth aspect is equipped with a light guide for guiding the optical signal output from the signal output part in each of the plurality of battery units to the signal receiving part. According to the above aspects, the optical signal output from the signal output part of each battery unit can be reliably and easily transmitted to the signal receiving part by the light guide.

The lithium-ion battery system according to any of specific example (seventh aspect) of the first to sixth aspect is equipped with an abnormality notification part for issue a notification when the state determination part determines the assembled battery as being abnormal. According to the above aspects, since a notification is issued when it is determined that an abnormality occurs in the assembled battery, it is possible to promptly take appropriate measures such as stopping the use of the assembled battery or repairing the assembled battery.

The battery system estimation system according to an aspect (eight aspect) of the present invention is system for estimating the state of an assembled battery formed by stacking a plurality of battery units, each of the plurality of battery units including a unit cell composed of a lithium-ion battery and a signal output part for outputting an optical signal in accordance with the state of the unit cell, the system comprising a signal receiving part for receiving an optical signal output by the signal output part in each of the plurality of battery units; an analysis processing part for analyzing the optical signal received by the signal receiving part so as to specify the number of unit cell in the abnormal state out of the unit cells in the plurality of battery units; and a state determination part for determining that the assembled battery is abnormal when the number specified by the analysis processing part exceeds the threshold value.

### Reference Signs List

S . . . battery system, 10 . . . assembled battery, 11 . . . positive electrode terminal, 12 . . . negative electrode terminal, 13 . . . light guide, 14 . . . exterior body, 15 . . . light receiving device, 200 . . . battery system estimation system, 21 . . . control device, 22 . . . storage device, 23 . . . communication device, 24 . . . notification device, 30 . . . unit cell, 31, 61 . . . positive electrode, 32, 62 . . . negative electrode, 33 . . . separator, 34, 63 . . . frame-like body, 40, 60 . . . signal output part, 41, 601 . . . wiring board, 42, 602 . . . temperature sensor, 43, 603 . . . voltage detecting part, 43a, 603a . . . first detection terminal, 43b, 603b . . . second detection terminal, 44, 604 . . . light emitting part, 45, 605 . . . light emission control part, 45a, 605a . . . first control part, 45b, 605b . . . second control part, 51 . . . analysis processing part, 52 . . . state determination part, 53 . . . notification control part, 100 . . . lithium-ion battery system, 131 . . . introducing part, 132 . . . propagating part, 200 . . . battery system estimation system, 311 . . . positive electrode current collector, 312 . . . positive electrode active material layer, 321 . . . negative electrode current collector, 322 . . . negative electrode active material layer, 410 . . . base body part, 411 . . . first extending part, 412 . . . second extending part, 500 . . . electric equipment, 606 . . . side wall portion, 607 . . . upper step portion, 608 . . . lower step portion, U . . . battery unit.

1. A lithium-ion battery system, comprising:
an assembled battery formed by stacking a plurality of battery units, each of the plurality of battery units including a unit cell consisting of a lithium-ion battery and a signal output part provided in the unit cell;
a signal receiving part for receiving an optical signal output by the signal output part in each of the plurality of battery units;
an analysis processing part for analyzing the optical signal received by the signal receiving part; and
a state determination part for determining that the assembled battery is abnormal in accordance with the analysis result of the analysis processing part,
wherein the signal output part generates a first optical signal by changing an optical signal pattern during a predetermined unit period in accordance with the state of the unit cell, and generates a second optical signal that is the optical signal pattern having the largest light emission period ratio in the unit period among the optical signal patterns when the unit cell is in an abnormal state; and
when the analysis processing part analyzes the second optical signal as being received by the signal receiving part, the state determination part determines the assembled battery as being abnormal.

2. The lithium-ion battery system according to claim 1, wherein each of the optical signal patterns is preset for each of the signal output parts, the first optical signal is an optical signal with a light emission period ratio of 0.01 or less in the unit period, and the second optical signal is an optical signal with a light emission period ratio of 0.1 or more in the unit period.

3. The lithium-ion battery system according to claim 2, wherein each of the plurality of battery units is provided with a light emission control part, a temperature sensor, and a light emitting part; and the light emission control part causes the light emitting part to output the optical signal indicating the abnormality of the unit cell when the temperature detected by the temperature sensor is higher or lower than the proper temperature range Qₙ.

4. The lithium-ion battery system according to claim 2, wherein each of the signal output part in each of the plurality of battery units includes a voltage detecting part for detecting a voltage of the unit cell in the battery unit concerned, and
the light emission control part controls the light emitting part to cause the light emitting part to output the optical signal corresponding to the temperature detected by the temperature sensor and the voltage detected by the voltage detecting part.

5. The lithium-ion battery system according to claim 2, wherein the light emitting part in each of the plurality of battery units emits light with different wavelengths, and
the analysis processing part analyzes the optical signal for each wavelength received by the signal receiving part.

6. The lithium-ion battery system according to claim 1, comprising:
a light guide for guiding the optical signal output from the signal output part in each of the plurality of battery units to the signal receiving part.

7. The lithium-ion battery system according to claim 1, comprising:
an abnormality notification part for issuing a notification when the state determination part determines the assembled battery as being abnormal.

8. The lithium-ion battery system according to claim 1, wherein the state determination part has an estimating part for estimating the abnormal state of a unit cell adjacent to an abnormal unit cell, which is determined by the analysis by the analysis processing part to be in the abnormal state, by the optical signal corresponding to the temperature detected by the temperature sensor provided in the abnormal unit cell, and
the state determination part determines the assembled battery as being abnormal in accordance with the estimation result by the estimating part.

9. The lithium-ion battery system according to claim 1, wherein the state determination part has an estimating part for estimating the abnormal state of a unit cell adjacent to an abnormal unit cell, which is determined by the analysis by the analysis processing part to be in the abnormal state, by the optical signal corresponding to the temperature detected by the temperature sensors provided in both the abnormal unit cell and the unit cell adjacent to the abnormal unit cell, and
the abnormality of the assembled battery is estimated in accordance with the analysis processing result by the analysis processing part and the estimation result by the estimating part.

10. An assembled battery state estimation system for estimating the state of an assembled battery, the assembled battery formed by stacking a plurality of battery units, each of the plurality of battery units including a unit cell consisting of a lithium-ion battery and a signal output part for outputting a first optical signal by changing an optical signal pattern during a predetermined unit period in accordance with the state of the unit cell, and outputting a second optical signal that is the optical signal pattern having the largest light emission period ratio in the unit period among the optical signal patterns when the unit cell is in an abnormal state, the system comprising:
a signal receiving part for receiving an optical signal output by the signal output part in each of the plurality of battery units;
an analysis processing part for analyzing the optical signal received by the signal receiving part; and
a state determination part for determining that the assembled battery is abnormal when the analysis by the analysis processing part indicates that the signal receiving part has received the second optical signal.
